(19) United States
(12) Patent Application Publication
(10) Pub. No.: US 2017/0095885 A1
(43) Pub. Date: Apr. 6, 2017

(54) Laser Welding Quality Determination Method and Laser Welding Apparatus Equipped with Quality Determination Mechanism

(71) Applicant: Hitachi Automotive Systems, Ltd., Hitachinaka-shi, Ibaraki (JP)

(72) Inventors: Xudong ZHANG, Tokyo (JP); Tatsuro KUROKI, Hitachinaka (JP); Masayuki ICHINOHE, Hitachinaka (JP)

(21) Appl. No.: 15/129,089

(22) PCT Filed: Feb. 3, 2015
(86) PCT No.: PCT/JP2015/053000

§ 371 Date: Sep. 26, 2016

(30) Foreign Application Priority Data
Mar. 31, 2014 (JP) 2014-070838

(51) Int. Cl. B23K 26/03; B29C 65/00; B29C 65/16; B23K 26/21; B23K 31/12

(52) U.S. Cl. CPC B23K 26/032; B23K 26/21; B23K 31/125; B29C 65/1648; B29C 66/1122; B29C 66/1222; B29C 66/974; B29C 65/16; B23K 2203/05

(57) ABSTRACT

An object of the invention is to provide a laser welding quality determination method for improving a determination accuracy of a welding quality which is strongly affected by an inner defect of a welding bead, and a laser welding apparatus which includes a mechanism for performing the quality determination method. There is provided a laser welding quality determination method of determining a welding quality in laser welding, including: capturing an image of a molten pool formed by emitting a laser beam to a welding target material to acquire image data of the molten pool; measuring a width of the molten pool in a direction orthogonal to a welding direction from the acquired image data of the molten pool; calculating a penetration depth from the measured width of the molten pool; and determining the welding quality from the measured width and the calculated penetration depth of the molten pool.

### TECHNICAL FIELD OF THE INVENTION

The present invention relates to a technology of laser welding, and particularly to a method of determining a welding quality in laser welding and a laser welding apparatus equipped with a mechanism which performs the quality determination method.

### DESCRIPTION OF BACKGROUND ART

The laser welding is a welding method in which a condensed laser beam (pulse wave or continuous wave) as a heat source is emitted to a welding target material to partially melt and solidify the welding target material. Since the laser beam is easily focused on a very small point using optical-system lenses, the energy density can be increased compared to other welding methods. As a result, the laser welding can make the welding deep with a high speed and with a high accuracy, and is advantageous that a welding deformation is less.

The laser welding has a wide range of available welding target materials, and can also be applied to non-metallic materials such as a resin material and a ceramic material including a metallic material such as a steel material (for example, stainless steel and carbon steel), an aluminum alloy, and a nickel alloy. In addition, a butt welding and a lap welding are available as a type of a welding joint. For example, a welding process for various types of products such as a car body, a fuel pump, an injector (fuel injection valve), an air-flow sensor, and a stress/distortion sensor in an automobile industry field.

An index indicating a welding quality of the welded product (the welding joint) is different depending on a product. In general, strength and sealability of the joint are important indexes. In order to achieve requested strength and sealability of the joint, it is essential that a sufficient amount of penetration depth is secured and no defect (for example, a welding crack and a blowhole) occurs in the welding portion (welding bead).

An automation of a welding work has an effect of significantly reducing the cost, and the laser welding is a welding method which is applied to the automatic welding machine for such an advantage. On the other hand, the welding is established on a delicate balance between an input heat amount to the welding portion and a heat radiation amount from the welding portion. Therefore, the welding is easily affected from a change in processing conditions thereof and a change in ambient environments. Further, there is a technical difficulty that the welding quality is easily deviated. For this reason, there is required a method of determining the welding quality in welding with accuracy and high speed in order to progress the automation of the welding.

For example, PTL 1 (WO 2011/024904 A1) discloses a laser welding quality determination method of determining the welding quality of the welding portion in a laser welding. In the method, the welding portion and the vicinity thereof are captured using a high-speed camera. The number of spatters, a high-luminance area, and a frequency of detecting a keyhole per unit length in the captured image are analyzed as parameters. The welding quality of the welding portion is determined by comparing the analyzed parameters with a comparison table which has been prepared. The welding quality result is displayed on a monitor. In addition, there is disclosed a laser welding quality determination apparatus which determines the welding quality of the welding portion in the laser welding. The apparatus includes a high-speed camera which captures the welding portion and the vicinity thereof, an analysis unit which performs image analysis on a parameter in the captured image to determine the welding quality of the welding portion, and a monitor which displays the welding quality of the welding portion determined by the analysis unit.

### CITATION LIST

### Patent Literature

PTL 1: International Publication No. WO 2011/024904 A1

### SUMMARY OF THE INVENTION

### Problems to be Solved by the Invention

According to PTL 1 (WO 2011/024904 A1), shear strength prediction or fracture mode prediction as well as the quality determination of the welding portion in the laser welding can be performed in-process. As a result, a quality management can be made in correspondence with the high-speed and high-accuracy laser welding. The quality determination method of PTL 1 can estimate an occurrence rate of the surface defect of the welding bead such as a bead or a blowhole. However, there is a problem in that there is a difficulty in determining the welding quality such as joint strength and sealability which are strongly affected by an inner defect of the welding bead.

Therefore, an object of the invention is to provide a laser welding quality determination method for improving a determination accuracy of a welding quality which is strongly affected by an inner defect of the welding bead, and a laser welding apparatus which includes a mechanism for performing the quality determination method.

### Solution to Problems

(I) According to one aspect of the present invention, there is provided a laser welding quality determination method for determining a welding quality in laser welding, including the steps of: capturing an image of a molten pool formed by emitting a laser beam to a welding target material to acquire image data of the molten pool; measuring a width of the molten pool in a direction orthogonal to a welding direction from the acquired image data of the molten pool; calculating a penetration depth from the measured width of the molten pool; and determining the welding quality from the measured width and the calculated penetration depth of the molten pool.

In the above aspect (I) of the invention, the following modifications and changes can be made.

(i) In the step of measuring of the width of the molten pool, a luminance of radiation light at the time of welding the welding target material is set to a luminance threshold, a portion showing a luminance equal to or more than the luminance threshold in the image data of the molten pool is detected as the molten pool, and a maximum value among distances between two points showing the luminance threshold in the direction orthogonal to the welding direction is set to the width of the molten pool.

(ii) In the step of calculating of the penetration depth, the penetration depth is calculated by checking the measured width of the molten pool with a predetermined database.

(iii) The laser welding quality determination method further includes the step of: measuring a length of the molten pool in the welding direction from the acquired image data of the molten pool, wherein, in the step of calculating of the penetration depth, the penetration depth is calculated from the measured width of the molten pool and the measured length of the molten pool.

(iv) In the step of calculating of the penetration depth, the penetration depth is calculated by checking the measured width and the measured length of the molten pool with a predetermined database.

(v) In the step of determining of the welding quality, the welding quality is determined from the measured width of the molten pool, the measured length of the molten pool, and the calculated penetration depth.

(II) According to another aspect of the present invention, there is provided a laser welding quality determination method of determining a welding quality in laser welding, including the steps of: capturing an image of a molten pool formed by emitting a laser beam to a welding target material to acquire image data of the molten pool; measuring a width of the molten pool in a direction orthogonal to a welding direction from the acquired image data of the molten pool; and determining a welding quality from the measured width of the molten pool and a penetration depth of a predetermined database.

In the above aspect (II) of the invention, the following modifications and changes can be made.

(vi) In the step of measuring of the width of the molten pool, a luminance of radiation light at the time of welding the welding target material is set to a luminance threshold, a portion showing a luminance equal to or more than the luminance threshold in the image data of the molten pool is detected as the molten pool, and a maximum value among distances between two points showing the luminance threshold in the direction orthogonal to the welding direction is set to the width of the molten pool.

(vii) The laser welding quality determination method further includes the step of: measuring a length of the molten pool in the welding direction from the acquired image data of the molten pool, wherein, in the step of determining of the welding quality, the welding quality is determined from the measured width of the molten pool and the measured length of the molten pool, and the penetration depth of the database.

(III) According to still another aspect of the present invention, there is provided a laser welding apparatus which has a mechanism of determining a welding quality in laser welding, including: a laser head which forms a molten pool by emitting a laser beam to a welding target material; and a laser welding quality determination mechanism which determines a welding quality, wherein the laser welding quality determination mechanism includes an image capturing device which captures an image of the molten pool to acquire image data of the molten pool, and a data processing device which analyzes the image data, and wherein the data processing device includes: a luminance measurement mechanism which measures a luminance of the image data of the molten pool; a molten pool shape measurement mechanism which measures a width of the molten pool in a direction orthogonal to a welding direction on the basis of the luminance; a first database which records a penetration depth corresponding to the width of the molten pool; and a second database which records the determination on the welding quality on the basis of the width and the penetration depth of the molten pool.

(IV) According to still another aspect of the present invention, there is provided a laser welding apparatus which has a mechanism of determining a welding quality in laser welding, including: a laser head which forms a molten pool by emitting a laser beam to a welding target material; and a laser welding quality determination mechanism which determines a welding quality, wherein the laser welding quality determination mechanism includes an image capturing device which captures an image of the molten pool to acquire image data of the molten pool, and a data processing device which analyzes the image data, and wherein the data processing device includes: a luminance measurement mechanism which measures a luminance of the image data of the molten pool; a molten pool shape measurement mechanism which measures a width of the molten pool in a direction orthogonal to a welding direction on the basis of the luminance; and a database which records a penetration depth corresponding to the width of the molten pool, and the determination on the welding quality on the basis of the width of the molten pool and the penetration depth.

### Advantages of the Invention

According to the invention, it is possible to provide a laser welding quality determination method for improving a determination accuracy of a welding quality which is strongly affected by an inner defect of a welding bead. In addition, it is possible to provide a laser welding apparatus which includes a mechanism for performing the quality determination method.

### BRIEF DESCRIPTION OF THE DRAWINGS

FIG. 1 is a diagram schematically illustrating an exemplary configuration and an exemplary application of a laser welding apparatus according to a first embodiment of the invention;

FIG. 2 is a diagram illustrating image data as an example of a molten pool captured by an image capturing device of the laser welding apparatus of the first embodiment;

FIG. 3 is a diagram schematically illustrating an exemplary method of measuring a width and a length of the molten pool;

FIG. 4 is a diagram schematically illustrating an exemplary cross-sectional shape of a welding bead obtained in the first embodiment;

FIG. 5 is a diagram schematically illustrating an example of a determination criterion for a welding quality based on a database (a relation between a width and a penetration depth of the molten pool) in consideration of a deviation in the shape of the molten pool;

FIG. 6 is a flowchart illustrating a welding quality determination method of the first embodiment (process flow of FIGS. 2 to 5);

FIG. 7 is a flowchart illustrating a welding quality determination method according to a second embodiment;

FIG. 8 is a diagram schematically illustrating an exemplary configuration and an exemplary application of a laser welding apparatus according to a third embodiment of the invention;

FIG. 9 is a diagram schematically illustrating an exemplary configuration and an exemplary application of a laser welding apparatus according to a fourth embodiment of the invention;

FIG. 10 is a diagram schematically illustrating an exemplary cross-sectional shape of the welding bead obtained in the fourth embodiment;

FIG. 11 is a diagram schematically illustrating another exemplary cross-sectional shape of the welding bead obtained in the fourth embodiment;

FIG. 12 is a diagram schematically illustrating another exemplary cross-sectional shape of the welding bead obtained in the fourth embodiment;

FIG. 13 is a diagram schematically illustrating an exemplary configuration and an exemplary application of a laser welding apparatus according to a fifth embodiment of the invention;

FIG. 14 is a diagram schematically illustrating an exemplary cross-sectional shape of the welding bead obtained in the fifth embodiment; and

FIG. 15 is a diagram schematically illustrating another exemplary cross-sectional shape of the welding bead obtained in the fifth embodiment.

### DETAILED DESCRIPTION OF THE PREFERRED EMBODIMENTS

Hereinafter, embodiments of the invention will be described in detail with reference to the drawings. Further, the invention is not limited to the embodiments given herein, and may be appropriately combined and improved within a scope not departing from a technical idea of the invention.

### First Embodiment

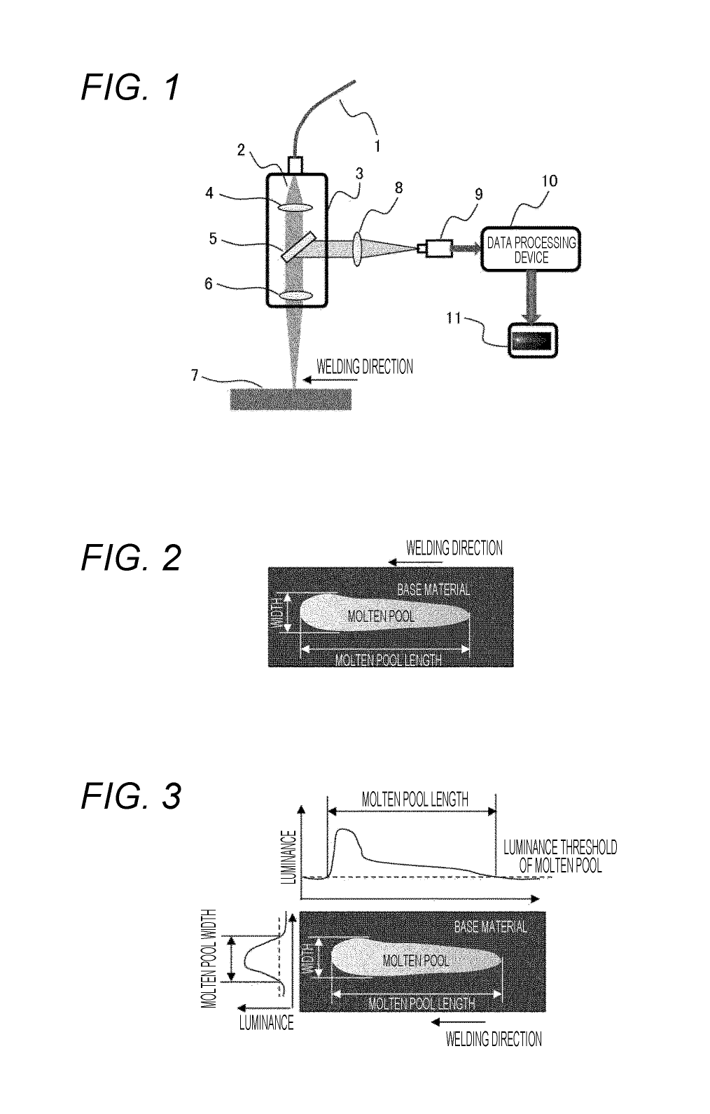

FIG. 1 is a diagram schematically illustrating an exemplary configuration and an exemplary application of a laser welding apparatus according to a first embodiment of the invention. In this embodiment, the description will be made about an example in a case where a butt welding is performed using a stainless steel plate (thickness: 2.0 mm) as a welding joint using a fiber laser (wavelength: 1,070 to 1,080 nm) as a heat source. Of course, other materials may be used as the welding joint, and the laser beam having other wavelengths may be used.

A method and a procedure of a laser welding in this embodiment will be described.

A laser beam 2 generated by a laser oscillator (not illustrated) is introduced into a laser head 3 through a transmission fiber 1. After passing through a collimation lens 4 and a half mirror 5 in the laser head 3, the laser beam is condensed by a laser-beam condensing lens 6. Then, the laser beam is emitted to a welding target material 7 to which the stainless steel plate is butted. In a case where the welding target material 7 is fixed, the welding is progressed while moving the laser head 3 in a welding direction in the drawing. In a case where the laser head 3 is fixed, the welding is progressed while moving the welding target material 7 in a direction reversed to the welding direction in the drawing. In other words, a relative moving direction with respect to the welding target material 7 of the laser beam 2 emitted to the welding target material 7 is set to the welding direction.

The emission of the laser beam 2 onto the surface of the welding target material 7 makes a molten pool formed, and radiation light caused from the welding of the welding target material 7 is emitted. The radiation light from the molten pool passes through the condensing lens 6, is reflected by the half mirror 5 to a direction different from that of the collimation lens 4, is condensed onto a camera condensing lens 8 attached to the front side of an image capturing device 9 (for example, a camera), and then is incident into the image capturing device (camera) 9. Image data captured by the camera 9 is analyzed by a data processing device 10. The analyzed result is displayed on a display device 11 (for example, an image monitor).

In this embodiment, since the half mirror 5 is installed on the optical axis of the laser beam 2, it means that the optical axis of the camera 9 is installed on the optical axis of the laser beam 2. As a result, the shape of the molten pool captured by the camera 9 has the same shape as that of the actual molten pool. Therefore, an actual size of the molten pool can be calculated from focal distances of the laser-beam condensing lens 6 and the camera condensing lens 8 and the size of the molten pool in the captured image.

FIG. 2 is a diagram illustrating the exemplary image data of the molten pool captured by the camera of the laser welding apparatus of the first embodiment. The white area in the drawing indicates a range of the molten pool.

As illustrated in FIG. 2, a width and a length of the molten pool can be measured from the acquired image data of the molten pool using an image processing method. In the invention, a maximum length of the molten pool in a direction orthogonal to the welding direction is defined as the width of the molten pool. A maximum length of the molten pool in the welding direction is defined as the length of the molten pool.

FIG. 3 is a diagram schematically illustrating an exemplary method of measuring the width and the length of the molten pool. In a case where the width of the molten pool is measured, a luminance distribution is measured along a direction orthogonal to the welding direction. The luminance is measured by a luminance measurement mechanism (not illustrated) in the data processing device 10. As illustrated in FIG. 3, the center of the molten pool when viewed from the welding direction (the center of the molten pool in a direction orthogonal to the welding direction) is an area to which the condensed laser beam is emitted (an area where an inflow amount of heat is larger than a radiation amount of heat). Therefore, the molten pool is increased in temperature, and the luminance of the radiation light is also heightened. Since both ends of the molten pool when viewed from the welding direction (both ends of the molten pool in a direction orthogonal to the welding direction) are separated away from the emission area of the laser beam, the radiation amount of heat becomes large. Since the both ends are also positioned in a boundary (for example, a melting point) where the welding target material 7 (base material) remains in the welding state, the luminance of the radiation light also becomes low. The width of the molten pool is, for example, 1 to 20 mm.

In a case where the length of the molten pool is measured, a luminance distribution is measured along the welding direction. As illustrated in FIG. 3, the left side of the molten pool in the drawing (the front side in the welding direction) corresponds to an area where it is not long before the laser emission (an area where the inflow amount of heat is larger than the radiation amount of heat). Therefore, the temperature of the molten pool becomes high, and the luminance of the radiation light also becomes high. As it goes to the right side of the molten pool in the drawing (the rear side in the welding direction), the cooling is progressed (the radiation amount of heat becomes larger than the inflow amount of heat), the temperature of the molten pool becomes lower, and the luminance of the radiation light also becomes lower. The length of the molten pool is, for example, 3 to 20 mm.

When the molten pool is determined, it is desirable that the luminance of the radiation light be separately measured at the time of melting the welding target material, and a luminance threshold for determining whether it is a melting state be set in advance. A lump of portion having a luminance equal to or more than the luminance threshold in the acquired image data is determined as the molten pool. A portion having a luminance less than the luminance threshold is determined as a portion other than the molten pool. Therefore, the shape of the molten pool is detected.

Next, a distance between two points indicating the luminance threshold is obtained in the width direction (a direction orthogonal to the welding direction) of the detected molten pool. A position where the distance between these two points is maximized is the width of the molten pool. The length of the molten pool (the length in the welding direction) can also be similarly obtained. In this way, the transition of the shape (width and length) of the molten pool is measured from a change in luminance at four points. For example, a distance between any two points in the peripheral edge of the molten pool can be easily measured by binarizing the entire image.

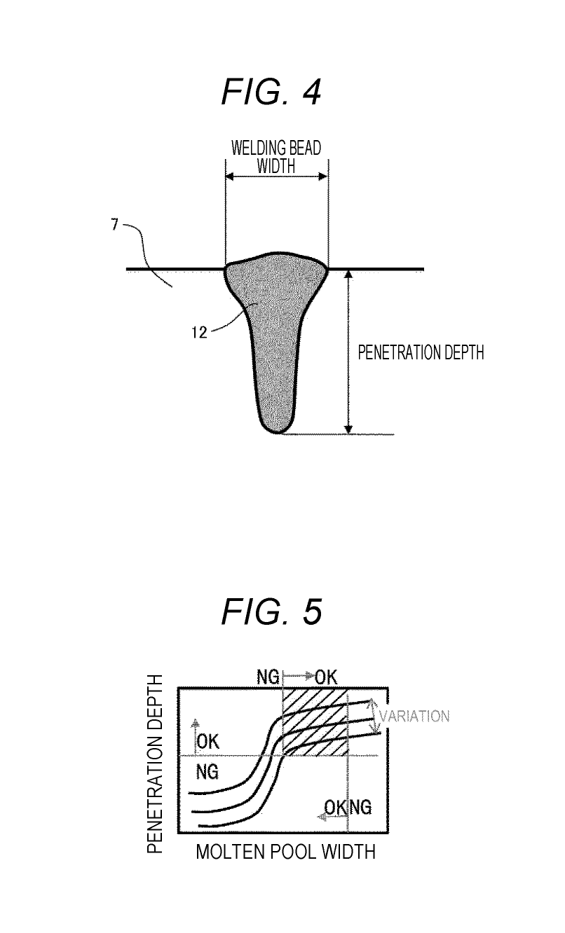

FIG. 4 is a diagram schematically illustrating an exemplary cross-sectional shape of a welding bead obtained in the first embodiment. FIG. 4 illustrates a cross-sectional view of a welded portion when viewed from the welding direction. A welding bead 12 is a portion cured after the molten pool is cooled down, and was the molten pool during a welding operation. In other words, the welding bead has the same width as that of the molten pool. There is a correlation between a width and a penetration depth of the molten pool when the laser is straightly emitted in welding. As the penetration depth is increased, the width of the molten pool is easily widened. This is because the heat is transferred even in the width direction of the welding target material 7 during the welding target material 7 is welded in the depth direction. As a result, the molten pool becomes widened.

It has been confirmed that the width of the molten pool is increased as the penetration depth is increased when the laser welding is performed on the stainless steel having a thickness of 2 mm used in this embodiment under various welding conditions (laser output: 500 to 3,000 W, beam spot diameter: 0.1 to 1.2 mm, and welding speed: 10 to 100 mm/s). It is desirable that the depths (=penetration depths) of the welding beads corresponding to the widths of various types of molten pools be recorded as a database in advance on the basis of this knowledge, and stored in the data processing device 10. The penetration depth particularly affects the welding quality such as strength and sealability of the welding portion. Therefore, when the penetration depth is used as a determination criterion for the welding quality, it contributes to an improvement of determination accuracy of the welding quality. The penetration depth can be estimated and calculated during the welding operation by checking the width of the molten pool obtained from the acquired image data with the database.

Furthermore, it is desirable that a database for determining the welding quality be created using the width of the obtained molten pool and the penetration depth, and stored in the data processing device 10. When the penetration depth equal to or more than a predetermined value can be secured, the welding strength can be guaranteed. In other words, there is a need to secure the penetration depth as much as a predetermined value or more in order to secure a requested welding strength. On the other hand, when the width of the molten pool is too wide, an undesirable deformation occurs in the welding, or a residual stress of the welding portion is increased. Therefore, it is desirable that the width of the molten pool be set to be equal to or less than a predetermined value. In other words, there is a need to secure the width of the molten pool to be equal to or less than the predetermined value in order to suppress the welding deformation and the residual stress.

However, as described above, the melting state of the welding target material is easily deviated (for example, the penetration depth is deviated even when the width of the molten pool is equal) by a variation in welding parameters (for example, fluctuation in the beam spot diameter due to fluctuation in the laser output and a variation in distance between the laser head and the welding target material) and a variation in the surrounding environment (for example, a variation in temperature). Therefore, it is desirable that these deviations be considered when the database is created.

FIG. 5 is a diagram schematically illustrating an exemplary determination criterion of the welding quality based on the database (a relation between the width and the penetration depth of the molten pool) in consideration of the deviation in the shape of the molten pool. As illustrated in FIG. 5, the welding quality is determined whether the width and the penetration depth of the molten pool obtained from the image data fall within a shaded area (OK) in the drawing. The penetration depth (inner information of the welding target material) can be obtained from the image data (surface information of the welding target material) of the molten pool. When the penetration depth is used as a determination criterion of the welding, it is possible to determine the welding quality (for example, the welding strength and the sealability) which is strongly correlated to the inner state of the welding bead. Therefore, it is possible to improve the determination accuracy of the welding quality.

In addition, when the database of the penetration depth is created on the basis of the data of both width and length of the molten pool, the information of an appropriate welding speed is also contained in the database. Both width and length of the molten pool are measured from the image data, and checked with the database to estimate and calculate the penetration depth. Therefore, it is possible to determine the welding quality with a higher accuracy.

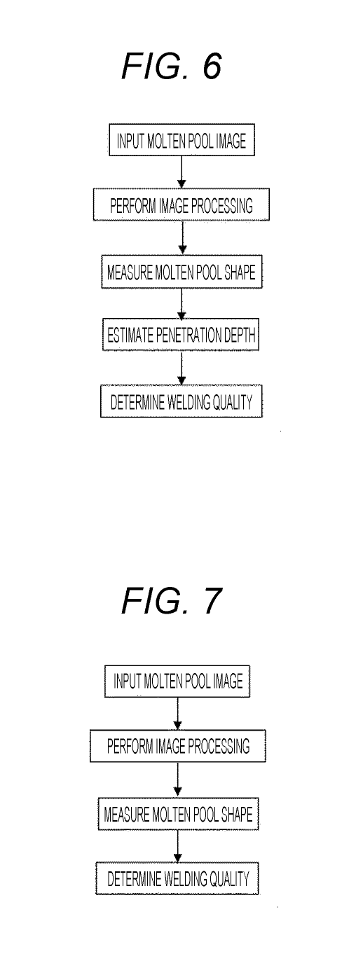

FIG. 6 is a flowchart illustrating a welding quality determination method of this embodiment (process flow of FIGS. 2 to 5). As illustrated in FIG. 6, first, the molten pool is captured using a camera, and the image data of the molten pool is input to the data processing device. Next, the acquired image data is subjected to the image processing to measure the shape (width and length) of the molten pool.

In a case where the welding quality is determined mainly using the width data of the molten pool, the penetration depth is estimated and calculated from the database which is previously created on the basis of a relation between the width and the penetration depth of the molten pool. After the penetration depth data is calculated, it is determined whether the width and the penetration depth of the molten pool fall within the area of a good welding quality with reference to the quality determination database which is created in advance (a quality determination database of the welding quality based on a relation between the width and the penetration depth of the molten pool). Therefore, the welding quality is determined.

In a case where the welding quality is determined using both the width data and the length data of the molten pool, the penetration depth is estimated and calculated from the database based on a relation between the molten pool width, the molten pool length, and the penetration depth created in advance. After calculating the data of the penetration depth, it is determined whether the molten pool width, the molten poll length, and the penetration depth fall within the area of a good welding quality with reference to the quality determination database which is created in advance (the quality determination database of the welding quality based on a relation between the molten pool width, the molten pool length, and the penetration depth). Therefore, the welding quality is determined.

### Second Embodiment

FIG. 7 is a flowchart illustrating a welding quality determination method according to a second embodiment. In the first embodiment described above, the penetration depth has been estimated and calculated using the molten pool width (or the molten pool width and the molten pool length) measured from the acquired image data, and the welding quality has been determined on the basis of whether the molten pool width and the penetration depth (or the molten pool width, the molten pool length, and the penetration depth) fall within a range of appropriate values. With this regard, as illustrated in FIG. 7, the second embodiment is different from the first embodiment in that the process of estimating and calculating the penetration depth using the measured molten pool width (or the molten pool width and the molten pool length) is omitted. In other words, in the second embodiment, the welding quality is directly determined from the value of the measured molten pool width (or the molten pool width and the molten pool length). This embodiment is effective in a case where there is a less deviation in a relation between the molten pool width and the penetration depth.

More specifically, as the quality determination database, there is used a database in which the penetration depth data corresponding to the input molten pool width data (or the molten pool width data and the molten pool length data) and appropriate range data determined from a combination of the penetration depth data and the input data. Therefore, the welding quality can be directly determined only from the measured value of the molten pool width (or the molten pool width and the molten pool length). According to this embodiment, the determination flow is simplified compared to the determination method illustrated in FIG. 6. Therefore, it is possible to determine the quality at a higher speed (in the shorter period).

### Third Embodiment

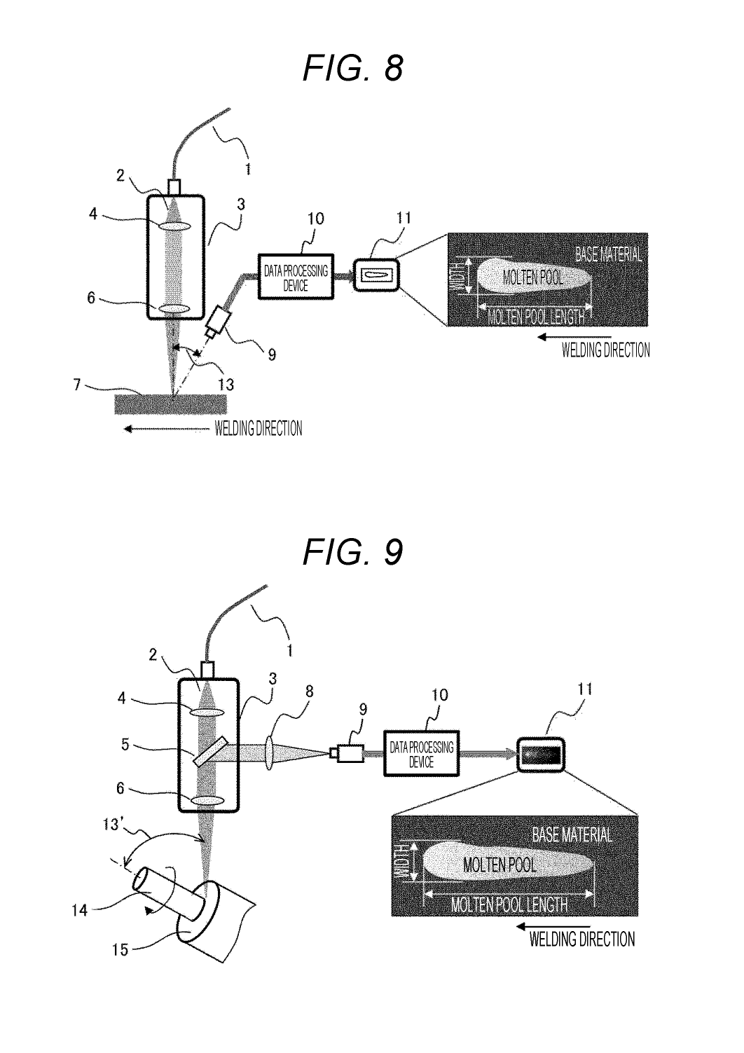

FIG. 8 is a diagram schematically illustrating an exemplary configuration and an exemplary application of a laser welding apparatus according to a third embodiment of the invention. The description in this embodiment will be made about an example in a case where a butting welding using the stainless steel plate (thickness: 1.2 mm) as the welding joint is performed, and a laser having wavelength (500 to 880 nm) from visible to near infrared light is used as the laser serving as the heat source.

A method and a procedure of a laser welding in this embodiment will be described. The laser beam 2 generated by a laser oscillator (not illustrated) is introduced into the laser head 3 through the transmission fiber 1. After passing through a collimation lens 4 in the laser head 3, the laser beam is condensed by the laser-beam condensing lens 6. The laser beam is emitted onto the surface of the welding target material 7 to which the stainless steel plate is butted. The emission of the laser beam 2 onto the surface of the welding target material 7 makes a molten pool formed, and radiation light caused from the welding of the welding target material 7 is emitted.

This embodiment is different from the first embodiment in that the half mirror is not provided in the laser head 3 and the optical axis of the camera 9 is not installed on the optical axis of the laser beam 2 but forming a predetermined angle with respect to a laser beam axis. The other configurations are the same as those of the first or second embodiment. The welding is performed in a state where an angle between the optical axis of the camera 9 (the radiation light incident on the camera 9 depicted by a chain line) and the laser beam axis is kept constant without changing a relative position between the laser head 3 and the camera 9. The camera 9 in this embodiment is installed, for example, at a position in the rear of the laser beam 2 along the welding direction while an angle 13 formed between the optical axis of the camera 9 and the laser beam axis is kept at 30°. It is a matter of course that the angle 13 is not limited to 30°.

In this embodiment, the axis of the radiation light incident onto the camera 9 is not disposed coaxially with the laser beam axis. Therefore, the shape (for example, width, length, and a ratio therebetween) of the molten pool captured by the camera 9 is not matched with the actual shape of the molten pool. However, the actual size of the molten pool can be calculated from the relative position between the laser head 3, the welding target material 7, and the camera 9 (for example, the focal distance of the laser-beam condensing lens 6, the angle 13 formed between the optical axis of the camera 9 and the laser beam axis, and the shape of the molten pool in the image data).

### Fourth Embodiment

FIG. 9 is a diagram schematically illustrating an exemplary configuration and an exemplary application of a laser welding apparatus according to a fourth embodiment of the invention. The description in this embodiment will be made about an example in a case where a fitting-in welding using two cylindrical welding target materials 14 and 15 serving as the welding joint different in diameter is performed, and a laser having wavelength (500 to 880 nm) from visible to near infrared light is used as the laser serving as the heat source.

As illustrated in FIG. 9, similarly to the laser welding apparatus of the first embodiment, the laser welding apparatus used in this embodiment is configured such that the half mirror 5 is installed on the optical axis of the laser beam 2 in the laser head 3, and the optical axis of the camera 9 can be considered as being installed on the optical axis of the laser beam 2. In addition, in the fitting-in welding of this embodiment, the cylindrical welding target material 14 is fitted into the inner space of the cylindrical welding target material 15, and the laser beam 2 is emitted to a contact portion between the two cylindrical welding target materials while rotating the fitted two cylindrical welding target materials so as to weld the two materials. At this time, the cylindrical welding target materials 14 and 15 are disposed such that an angle 13′ between the rotation axis thereof and the laser beam axis becomes 600.

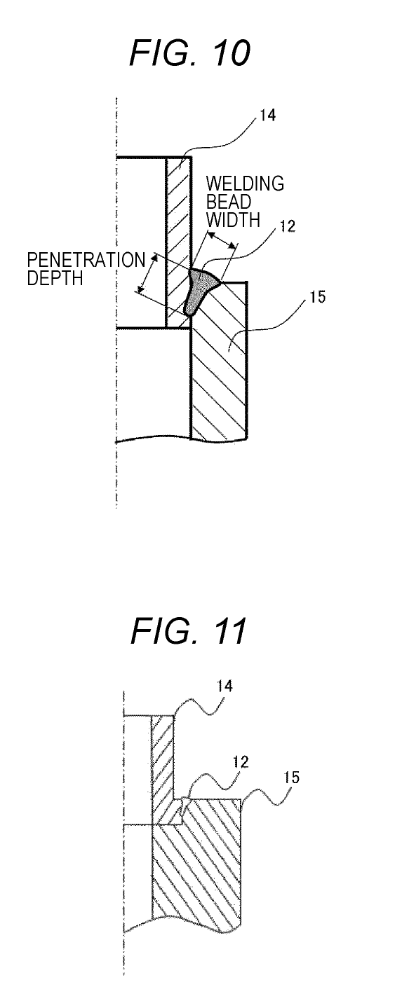

FIG. 10 is a diagram schematically illustrating an exemplary cross-sectional shape of the welding bead obtained in the fourth embodiment. The width of the welding bead 12 in this embodiment (that is, the width of the molten pool) is different from the molten pool width in a case where the laser is emitted onto the flat surface. The width depends on the angle 13′ formed between the rotation axis of the cylindrical welding target materials 14 and 15 and the laser beam axis. Therefore, the molten pool width of the image data is desirably corrected using the angle when the image data captured by the camera 9 is analyzed. In addition, the welding in this embodiment is performed in a circumferential direction of the cylindrical welding target material. Therefore, strictly speaking, the surface of the molten pool is a curved surface in the welding direction (the cross section of the molten pool in the length direction is an arc shape). Therefore, in order to obtain the actual molten pool length, the molten pool length of the captured image data is desirably corrected using a distance (a rotational radius of the welding portion) from the center of the molten pool to the rotation axis of the welding target material. However, in a case where the diameter of the cylindrical welding target material in the welding portion is sufficiently large compared to the molten pool length, the surface of the molten pool can be considered as an appropriate flat surface. Therefore, the molten pool length of the captured image data may be employed without any change.

The determination of the welding quality can be performed similarly to the first embodiment. Specifically, the image data of the molten pool is acquired using the camera 9, and analyzed using an image processing program installed in the data processing device 10 to measure the width (or the width and the length) of the molten pool. Thereafter, the penetration depth is estimated and calculated from the database of the relation between the molten pool width and the penetration depth stored in the data processing device 10 in advance, or the database of the relation between the molten pool width, the molten pool length, and the penetration depth. After the penetration depth data is estimated and calculated, the welding quality is determined with reference to the quality determination database (the database based on the threshold of the molten pool width and the threshold of the penetration depth, or the database based on the threshold of the molten pool width, the threshold of the molten pool length, and the threshold of the penetration depth) stored in the data processing device 10 in advance.

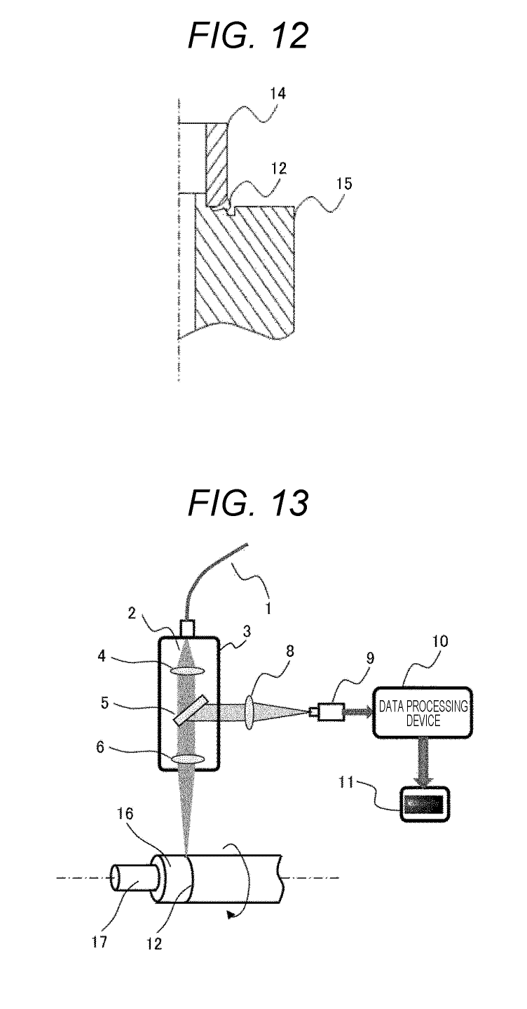

FIGS. 11 and 12 are diagrams schematically illustrating another exemplary cross-sectional shape of the welding bead obtained in the fourth embodiment. As illustrated in FIGS. 11 and 12, the welding joint in this embodiment may be a butting joint of the cylindrical welding target materials 14 and 15. In addition, the determination of the welding quality in this embodiment may be the same as that of the second embodiment, or the laser welding apparatus may have the same configuration as that of the third embodiment.

### Fifth Embodiment

FIG. 13 is a diagram schematically illustrating an exemplary configuration and an exemplary application of a laser welding apparatus according to a fifth embodiment of the invention. The description in this embodiment will be made about an example in a case where a lap welding is performed using two cylindrical welding target materials 16 and 17 different in outer diameter as the welding joint, and the fiber laser (wavelength: 1,070 to 1,080 nm) is used as the laser serving as the heat source.

As illustrated in FIG. 13, the laser welding apparatus used in this embodiment has the same configuration as that of the laser welding apparatus of the first embodiment. In addition, in the lap welding in this embodiment, the cylindrical welding target material 17 is fitted into the inner space of the cylindrical welding target material 16, the laser beam 2 is vertically emitted from above the outer cylindrical welding target material 16 while rotating the fitted two cylindrical welding target materials, and the cylindrical welding target material 16 is passed through by the laser beam (the molten pool is formed to pass through the cylindrical welding target material 16 and to reach the cylindrical welding target material 17) so as to weld the two materials. At this time, the cylindrical welding target materials 16 and 17 are disposed such that the rotation axis is orthogonal to the laser beam axis.

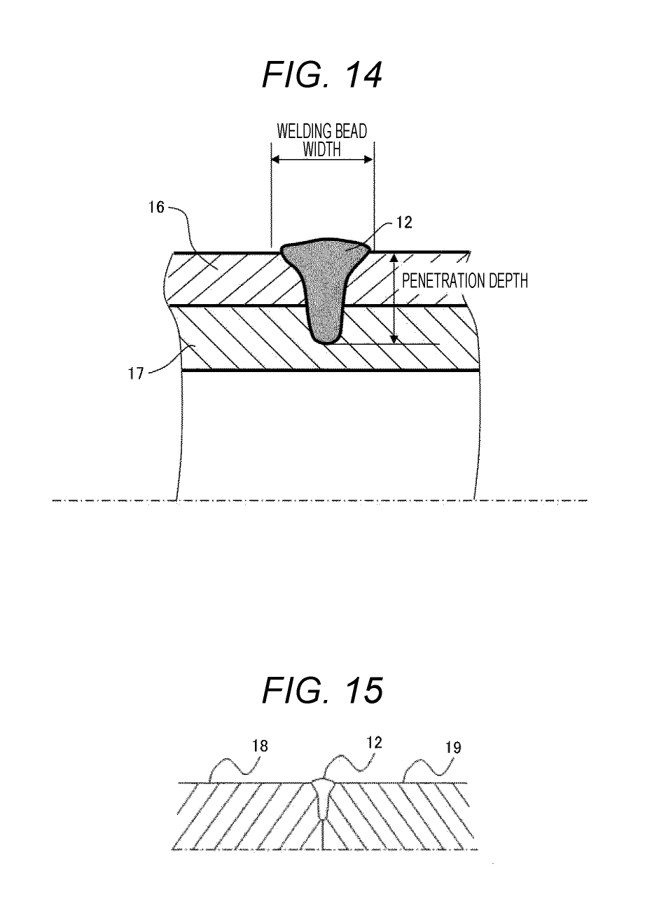

FIG. 14 is a diagram schematically illustrating an exemplary cross-sectional shape of the welding bead obtained in the fifth embodiment. The width of the welding bead 12 (that is, the width of the molten pool) in this embodiment is the same as the molten pool width in a case where the laser is emitted to the flat surface. Therefore, the penetration depth can be estimated and calculated similarly to the first embodiment, and the welding quality can be determined. In addition, in a case where the molten pool length is measured, the welding quality may be determined after the molten pool length of the image data is corrected according to the outer diameter of the cylindrical welding target material 16 similarly to the fourth embodiment.

FIG. 15 is a diagram schematically illustrating another exemplary cross-sectional shape of the welding bead obtained in the fifth embodiment. As illustrated in FIG. 15, the welding joint in this embodiment may be a butting joint of two columnar welding target materials 18 and 19 having the same outer diameter.

The above-described embodiments have been specifically given in order to help with understanding on the invention, but the invention is not limited to the configuration equipped with all the components described above. For example, some of the configurations of a certain embodiment may be replaced with the configurations of the other embodiments, and the configurations of the other embodiments may be added to the configurations of the subject embodiment. Furthermore, some of the configurations of each embodiment may be omitted, replaced with other configurations, and added to other configurations.

### LEGEND

1 . . . transmission fiber;
2 . . . laser beam;
3 . . . laser head;
4 . . . collimation lens;
5 . . . half mirror;
6 . . . condensing lens;
7 . . . welding target material;
8 . . . condensing lens;
9 . . . image capturing device (camera);
10 . . . data processing device;
11 . . . display device;
12 . . . welding bead;
13, 13′ . . . angle formed with respect to laser beam axis;
14 to 17 . . . cylindrical welding target material; and
18, 19 . . . columnar welding target material.

1. A laser welding quality determination method for determining a welding quality in laser welding, comprising the steps of:
capturing an image of a molten pool formed by emitting a laser beam to a welding target material to acquire image data of the molten pool;
measuring a width of the molten pool in a direction orthogonal to a welding direction from the acquired image data of the molten pool;
calculating a penetration depth from the measured width of the molten pool; and
determining the welding quality from the measured width and the calculated penetration depth of the molten pool.

2. The laser welding quality determination method according to claim 1,
wherein, in the step of measuring of the width of the molten pool, a luminance of radiation light at the time of welding the welding target material is set to a luminance threshold, a portion showing a luminance equal to or more than the luminance threshold in the image data of the molten pool is detected as the molten pool, and a maximum value among distances between two points showing the luminance threshold in the direction orthogonal to the welding direction is set to the width of the molten pool.

3. The laser welding quality determination method according to claim 1,
wherein, in the step of calculating of the penetration depth, the penetration depth is calculated by checking the measured width of the molten pool with a predetermined database.

4. The laser welding quality determination method according to claim 1, further comprising the step of:
measuring a length of the molten pool in the welding direction from the acquired image data of the molten pool,
wherein, in the step of calculating of the penetration depth, the penetration depth is calculated from the measured width of the molten pool and the measured length of the molten pool.

5. The laser welding quality determination method according to claim 4,
wherein, in the step of calculating of the penetration depth, the penetration depth is calculated by checking the measured width and the measured length of the molten pool with a predetermined database.

6. The laser welding quality determination method according to claim 4,
wherein, in the step of determining of the welding quality, the welding quality is determined from the measured width of the molten pool, the measured length of the molten pool, and the calculated penetration depth.

7. A laser welding quality determination method of determining a welding quality in laser welding, comprising the steps of:
capturing an image of a molten pool formed by emitting a laser beam to a welding target material to acquire image data of the molten pool;
measuring a width of the molten pool in a direction orthogonal to a welding direction from the acquired image data of the molten pool; and
determining a welding quality from the measured width of the molten pool and a penetration depth of a predetermined database.

8. The laser welding quality determination method according to claim 7,
wherein, in the step of measuring of the width of the molten pool, a luminance of radiation light at the time of welding the welding target material is set to a luminance threshold, a portion showing a luminance equal to or more than the luminance threshold in the image data of the molten pool is detected as the molten pool, and a maximum value among distances between two points showing the luminance threshold in the direction orthogonal to the welding direction is set to the width of the molten pool.

9. The laser welding quality determination method according to claim 7, further comprising the step of:
measuring a length of the molten pool in the welding direction from the acquired image data of the molten pool,
wherein, in the step of determining of the welding quality, the welding quality is determined from the measured width of the molten pool and the measured length of the molten pool, and the penetration depth of the database.

10. A laser welding apparatus which has a mechanism of determining a welding quality in laser welding, the laser welding apparatus comprising:
a laser head which forms a molten pool by emitting a laser beam to a welding target material; and
a laser welding quality determination mechanism which determines a welding quality,
wherein the laser welding quality determination mechanism includes an image capturing device which captures an image of the molten pool to acquire image data of the molten pool, and a data processing device which analyzes the image data, and
wherein the data processing device includes:
a luminance measurement mechanism which measures a luminance of the image data of the molten pool;
a molten pool shape measurement mechanism which measures a width of the molten pool in a direction orthogonal to a welding direction on the basis of the luminance;
a first database which records a penetration depth corresponding to the width of the molten pool; and
a second database which records the determination on the welding quality on the basis of the width and the penetration depth of the molten pool.

11. A laser welding apparatus which has a mechanism of determining a welding quality in laser welding, the laser welding apparatus comprising:
a laser head which forms a molten pool by emitting a laser beam to a welding target material; and
a laser welding quality determination mechanism which determines a welding quality,
wherein the laser welding quality determination mechanism includes an image capturing device which captures an image of the molten pool to acquire image data of the molten pool, and a data processing device which analyzes the image data, and
wherein the data processing device includes:
a luminance measurement mechanism which measures a luminance of the image data of the molten pool;
a molten pool shape measurement mechanism which measures a width of the molten pool in a direction orthogonal to a welding direction on the basis of the luminance; and
a database which records a penetration depth corresponding to the width of the molten pool, and the determination on the welding quality on the basis of the width of the molten pool and the penetration depth.
